(19) United States
(12) Patent Application Publication
(10) Pub. No.: US 2023/0208017 A1
(43) Pub. Date: Jun. 29, 2023

(54) ANTENNA MODULE

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Kosuke SONE, Mie (JP); Ai TAKEHISA, Mie (JP); Norichika OOMI, Mie (JP); Yasuyuki YAMAMOTO, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/912,999

(22) PCT Filed: Mar. 12, 2021
(86) PCT No.: PCT/JP2021/009969

§ 371 Date: Sep. 20, 2022

(30) Foreign Application Priority Data
Mar. 26, 2020 (JP) 2020-055920

(51) Int. Cl. H01Q 1/32; H01Q 21/28; H01Q 1/24

(52) U.S. Cl. CPC H01Q 1/3275; H01Q 21/28; H01Q 1/24

(57) ABSTRACT

An antenna module includes: a functional sheet including a conductive layer and a layer having at least one of a heat insulating function and/or an acoustic insulating function; and an antenna unit including a ground conductor, wherein the functional sheet is disposed between a panel forming an outer shape of a vehicle and an interior member provided on a side closer to a vehicle interior than the panel, and the ground conductor is electrically connected to the conductive layer.

### TECHNICAL FIELD

The present disclosure relates to an antenna module.

### BACKGROUND ART

Patent Document 1 discloses an antenna unit disposed on an inner side of a roof panel made of insulative resin.

### PRIOR ART DOCUMENTS

### Patent Document(s)

Patent Document 1: Japanese Patent Application Laid-Open No. 2019-186810

### SUMMARY

### Problem to be Solved by the Invention

Particularly, in a case where the antenna unit is disposed on the inner side of the roof panel made of insulative resin as with Patent Document 1, for example, it is difficult to ground-connect the antenna unit to a body.

Accordingly, an object of the present disclosure is to provide a technique capable of easily ground-connecting an antenna unit of a vehicle.

### Means to Solve the Problem

An antenna module according to the present disclosure is an antenna module including: a functional sheet including a conductive layer and a layer having at least one of a heat insulating function and/or an acoustic insulating function; and an antenna unit including a ground conductor, wherein the functional sheet is disposed between a panel forming an outer shape of a vehicle and an interior member provided on a side closer to a vehicle interior than the panel, and the ground conductor is electrically connected to the conductive layer.

### Effects of the Invention

According to the present disclosure, the antenna unit of the vehicle is easily ground-connected.

### BRIEF DESCRIPTION OF DRAWINGS

FIG. 1 is a schematic perspective view illustrating a vehicle into which an antenna module according to an embodiment is incorporated.

FIG. 2 is an exploded schematic perspective view illustrating a portion into which the antenna module is incorporated in the vehicle.

FIG. 3 is a partial enlarged perspective view of the antenna module.

FIG. 4 is a cross-sectional view of an IV-IV line portion in FIG. 1.

FIG. 5 is a cross-sectional view illustrating an antenna module according to a modification example.

FIG. 6 is a cross-sectional view illustrating an antenna module according to another modification example.

FIG. 7 is a cross-sectional view illustrating an antenna module according to another modification example.

FIG. 8 is a cross-sectional view illustrating an antenna module according to another modification example.

FIG. 9 is an exploded schematic perspective view illustrating a portion into which an antenna module is incorporated in the vehicle according to another modification example.

FIG. 10 is a cross-sectional view of an X-X line portion in FIG. 9.

### DESCRIPTION OF EMBODIMENT(S)

### Description of Embodiment of Present Disclosure

Embodiments of the present disclosure are listed and described firstly.

An antenna module according to the present disclosure is as follows.

(1) An antenna module includes: a functional sheet including a conductive layer and a layer having at least one of a heat insulating function and/or an acoustic insulating function; and an antenna unit including a ground conductor, wherein the functional sheet is disposed between a panel forming an outer shape of a vehicle and an interior member provided on a side closer to a vehicle interior than the panel, and the ground conductor is electrically connected to the conductive layer. The ground conductor of the antenna unit is electrically connected to a conductive layer of the functional sheet. Thus, even if a metal portion is not located near the antenna unit, the antenna unit is easily ground-connected. Even in a case where the roof panel is not made of insulative resin, the antenna unit is electrically connected to the conductive layer of the functional sheet and is easily ground-connected. Thus, the application of the present antenna module is not based on a premise that the roof panel is made of insulative resin.

(2) In the antenna module according to (1), a connection part electrically connecting the conductive layer to a metal portion of a body may be provided to the functional sheet. The conductive layer is easily ground-connected to the metal portion of the body via the connection part.

(3) In the antenna module according to (1) or (2), it is also applicable that the antenna unit includes a ground plate electrically connected to the ground conductor, and the ground plate and the conductive layer face each other. The ground plate and the conductive layer face each other, thus the ground conductor is electrically connected to the conductive layer more stably.

(4) In the antenna module according to (3), it is also applicable that the ground plate includes an extension part extending from the antenna unit, and an additional connection part electrically connected to a metal portion of a body is provided to the extension part. The ground plate of the antenna unit is electrically connected to the metal portion of the body via the additional connection part. Thus, the antenna unit is ground-connected to the metal portion of the body more reliably.

### Details of Embodiment of Present Disclosure

Specific examples of an antenna module of the present disclosure are described hereinafter with reference to the drawings. The present disclosure is not limited to these examples, but is indicated by claims, and it is intended that meanings equivalent to claims and all modifications within a scope of claims are included.

### Embodiment 1

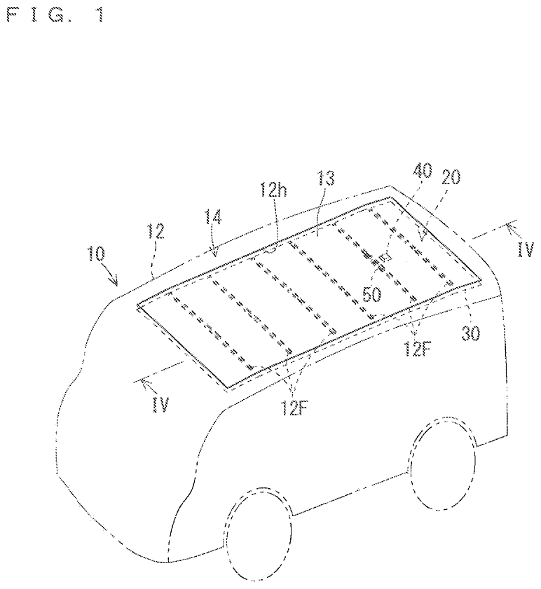

An antenna module according to an embodiment is described hereinafter. FIG. 1 is a schematic perspective view illustrating a vehicle 10 into which an antenna module 20 is incorporated.

The vehicle 10 includes a body 12. The body 12 is a part forming an outer shape of the vehicle 10. The body 12 may be a monocoque body or a body mounted on a ladder type frame. Herein, the body 12 includes a lateral panel surrounding a vehicle interior, a roof panel 13, a boarding door panel for a passenger to get in or out of a vehicle, and a rear door panel to take in and out a luggage, for example. The body 12 may include a frame supporting each panel. The roof panel 13 is a plate-like portion covering an upper side of the vehicle interior, and is an example of a panel constituting an outer shape of the body 12. The roof panel 13 may be partially or wholly curved, or may also have a wholly planar plate-like shape. The roof panel 13 is formed of resin. A portion of the body 12 except for the roof panel 13 may be formed of metal or resin, or may also be formed by a combination of metal and resin.

A roof panel opening 12h is formed in apart of the body 12 provided with the roof panel 13. The roof panel 13 is fitted into the roof panel opening 12h, thereby closing the roof panel opening 12h. A roof frame 12F is provided to pass across the roof panel opening 12h. A frame may be provided to surround the roof panel opening 12h. In this case, the roof frame 12F may be provided to connect a pair of lateral frames in the frame. The roof frame 12F is provided along a vehicle width direction herein. The plurality of (herein, six) roof frames 12F are provided at intervals in a front-back direction of a vehicle. The roof panel 13 is supported on the roof frame 12F in a state where the roof panel 13 is fitted into the roof panel opening 12h.

The roof frame 12F is an example of a metal portion of the body. The roof frame 12F may be electrically connected to the other portion of the body 12 formed of metal.

The antenna module 20 is incorporated into the vehicle 10. In the example described in the present embodiment, the antenna module 20 is incorporated into a roof 14 including the roof panel 13. The antenna module 20 may also be incorporated into the other unit such as a door, for example, in the vehicle 10.

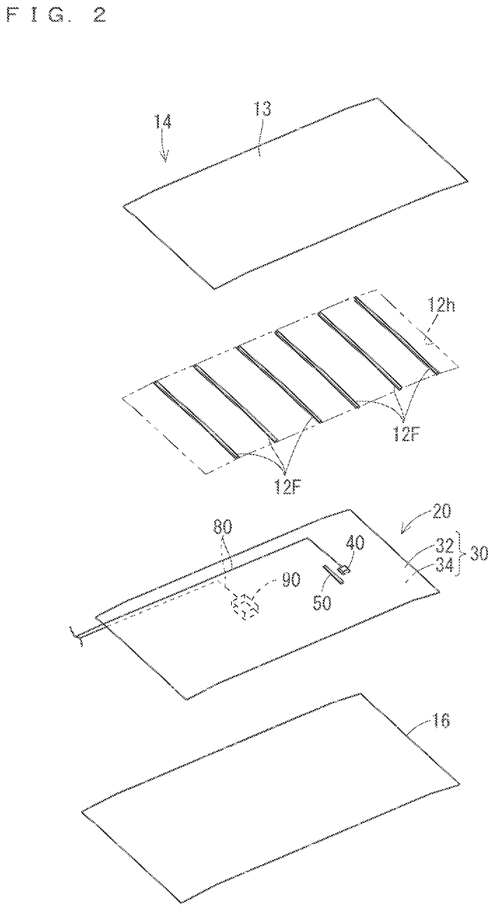

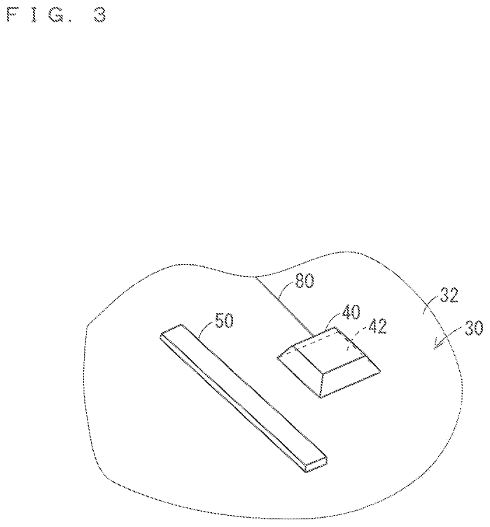

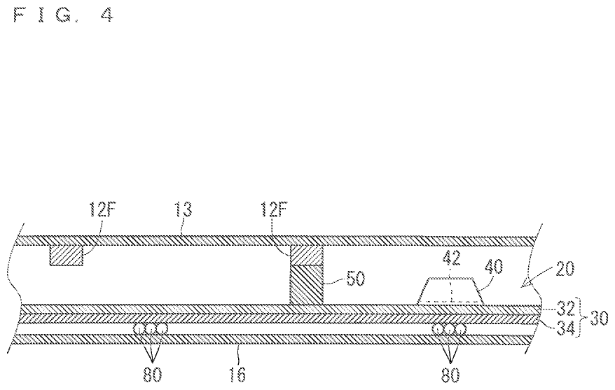

FIG. 2 is an exploded schematic perspective view illustrating a portion into which the antenna module 20 is incorporated in the vehicle 10. FIG. 3 is a partial enlarged perspective view of the antenna module 20. FIG. 4 is a cross-sectional view along a IV-IV line in FIG. 1.

The roof 14 includes the roof panel 13 and an interior member 16. The interior member 16 is a plate-like member formed of resin, for example. The interior member 16 may be partially or wholly curved to form a ceiling shape of the vehicle interior. The interior member 16 is attached to a lower side of the roof panel 13. The interior member 16 is a part exposed to the vehicle interior. The interior member 16 is also referred to as a roof liner in some cases. A peripheral edge part of the interior member 16 is attached to the body 12 or the other interior member, for example. Thus, the interior member 16 is supported in a certain position in the roof panel 13 on a side of the vehicle interior. In the present embodiment, the antenna module 20 is provided between the roof panel 13 and the interior member 16.

The antenna module 20 includes a functional sheet 30 and an antenna unit 40.

The functional sheet 30 is a sheet including a conductive layer 32. The functional sheet 30 is disposed between the roof panel 13 and the interior member 16.

The functional sheet 30 includes the conductive layer 32. Thus, the functional sheet 30 includes a radio shielding function by the conductive layer 32. The conductive layer 32 extends to be larger than the antenna unit 40. The conductive layer 32 may extend on the whole functional sheet 30. The conductive layer 32 may be a sheet formed of metal such as aluminum or iron.

The functional sheet 30 may include a layer 34 having at least one of a heat insulating function and/or an acoustic insulating function. The heat insulating function is a layer suppressing a heat transmission between one main surface and the other main surface of the functional sheet 30. The heat insulating function may be achieved by a layer reflecting heat radiation energy. The heat insulating function may be achieved by a low-thermal conductive layer. Specifically, a sheet including minute spaces such as a non-woven sheet or a foam sheet, for example, may be used as the layer having the heat insulating function. A heat insulating coating or a heat shielding coating may be used as the layer having the heat insulating function.

The acoustic insulating function is a layer suppressing a sound transmission between one main surface and the other main surface of the functional sheet 30. The acoustic insulating function may be achieved by a layer reflecting sound or a layer absorbing energy of sound as heat energy. Specifically, a sheet including minute spaces such as a non-woven sheet or a foam sheet, for example, may be used as the layer having the acoustic insulating function. A sound absorbing coating may be used as the layer having the acoustic insulating function.

The functional sheet 30 may include at least one of a layer having the heat insulating function and/or a layer having the acoustic insulating function. The functional sheet 30 may include a layer having both functions of the heat insulating function and the acoustic insulating function. In this case, the heat insulating function and the acoustic insulating function may be achieved by different layers or the same layer. For example, when the layer is made up of a non-woven sheet, the layer 34 doubles as the heat insulating function and the acoustic insulating function.

The conductive layer 32 and the layer 34 described above may be simply overlapped with each other. Each of the layers 32 and 34 may be fixed to each other by a double-sided tape, an adhesive agent, or welding, for example.

The functional sheet 30 is incorporated into the roof 14 to planarly extend over the roof 14. For example, the functional sheet 30 may be disposed to cover 80% or more of an area of the roof 14. For example, the functional sheet 30 may be disposed to extend over a whole upper side of head rests of a plurality of passenger seats in the vehicle. The functional sheet 30 is disposed to extend over the roof 14, thus the function of the functional sheet 30 acts in a region as large as possible in the roof 14. Described herein is an example that the functional sheet 30 extends over the same region as the roof panel 13.

The antenna unit 40 is a unit in which an antenna for performing wireless communication with a vehicle external apparatus is incorporated into an antenna substrate, for example. The antenna is an antenna for performing communication with a wireless base station in a public communication line or a private communication line, an antenna for vehicle-and-vehicle communication or road-and-vehicle communication, or an antenna for receiving a GPS signal, for example. The antenna may be an indoor antenna. The antenna may be a wireless charging antenna. The antenna unit 40 may include a plurality of antennas. The antenna unit 40 includes a ground conductor 42. The ground conductor 42 may be formed of metal foil formed in a print substrate, for example. The ground conductor 42 may be a portion of a patch antenna constituting a ground plate, for example. The ground conductor 42 may be provided to be directly exposed to a vehicle interior side of the antenna substrate. When the ground conductor 42 is provided on a surface (a surface directed to a vehicle outside) or an intermediate layer of the antenna substrate, the ground conductor 42 may be exposed to a rear surface (a surface on the vehicle interior side) of the antenna substrate via a via hole formed in the antenna substrate.

The antenna unit 40 is formed to have a thickness so that the antenna unit 40 can be disposed between the functional sheet 30 and the roof panel 13.

The antenna unit 40 is integrated with the functional sheet 30 while the ground conductor 42 is electrically connected to the conductive layer 32. The state where the antenna unit 40 is integrated with the functional sheet 30 indicates that the antenna unit 40 and the functional sheet 30 are combined with each other so that they can be transported as one module and assembled to a vehicle.

For example, the antenna unit 40 may be bonded to a surface of the functional sheet 30 on a side of the conductive layer 32 by a conductive adhesive agent based on a premise that the conductive layer 32 is disposed on a side of the roof panel 13. The conductive adhesive agent has a role of adhering to the functional sheet 30 and the antenna unit 40 to hold the antenna unit 40 in a constant position in the functional sheet 30. The conductive adhesive agent has contact with the ground conductor 42 or a conductor portion connected to the ground conductor 42 in the antenna unit 40, and has contact with a surface of the conductive layer 32, thereby having a role of electrically connecting the ground conductor 42 and the conductive layer 32.

The antenna unit 40 may be integrated with the functional sheet 30 by a through fixing member such as a screw or a rivet, for example. For example, it is also applicable that the antenna unit 40 is provided on a surface of the functional sheet 30 on a side of the conductive layer 32 and the a through fixing member such as a screw or a rivet passes through the functional sheet 30 to be screwed or fixed to the antenna unit 40 from an opposite side. In this case, the functional sheet 30 is sandwiched between a head of the through fixing member such as the screw or the rivet and the antenna unit 40, thus the antenna unit 40 is held in a constant position on the functional sheet 30. In this case, a bracket plate into which a screw is inserted may intervene between the head and the functional sheet 30. Accordingly, force of the head pressing the functional sheet 30 is dispersed by the bracket plate, thus the functional sheet 30 is hardly broken. In these cases, the ground conductor 42 exposed from the antenna unit 40 or the conductor portion connected to the ground conductor 42 has direct contact with the conductive layer 32, and is electrically connected to the conductive layer 32.

The antenna unit 40 is provided in a position of the functional sheet 30 between the roof frames 12F away from the roof frame 12F.

The functional sheet 30 is provided with a connection part 50 electrically connecting the conductive layer 32 to a metal portion (the roof frame 12F herein) of the body.

The connection part 50 is provided to a portion of the functional sheet 30 provided with the roof frame 12F. The connection part 50 intervenes between the conductive layer 32 and the roof frame 12F and fills a space therebetween, thereby electrically connecting the conductive layer 32 and the roof frame 12F, for example.

The connection part 50 is formed into a rectangular parallelepiped shape, for example. A length dimension of the connection part 50 is set to be equal to or smaller than the roof frame 12F. The connection part 50 is disposed on the conductive layer 32 while one of four lateral surfaces of the connection part 50 is disposed on a side of the conductive layer 32. A height dimension of the connection part 50 is set to be equal to or larger than a dimension between the conductive layer 32 and a lower surface of the roof frame 12F (larger than the dimension within a range capable of intervening between the conductive layer 32 and the roof frame 12F by compression deformation) while the connection part 50 is disposed on the conductive layer 32.

The connection part 50 may be formed of a conductive elastic member. For example, the conductive elastic member is a member made up of an elastic material such as rubber into which a conductive filler such as carbon or a metallic powder is mixed (conductive rubber, for example). When the connection part 50 is formed of the conductive elastic member, the conductive layer 32 is electrically connected to the roof frame 12F via the connection part 50 by pressing the connection part 50 against the roof frame 12F from a lower side of the functional sheet 30. At this time, the connection part 50 can be elastically deformed, thus a distance error between the conductive layer 32 and the roof frame 12F can be absorbed. Even when impact or vibration is applied to one of the functional sheet 30 and the roof panel 13, the impact or vibration is hardly transmitted to the other one thereof.

The connection part 50 may be bonded to the conductive layer 32 by a conductive adhesive agent, for example. Accordingly, when the functional sheet 30 is incorporated into a lower side of the roof panel 13, the connection part 50 is automatically disposed in a lower position of the roof frame 12F. The connection part 50 may be attached to the functional sheet 30 by a through fixing member such as a screw or a rivet in the manner similar to the antenna unit described above.

Any configuration is applicable to the configuration of pressing the connection part 50 described above toward the roof panel 13.

For example, as illustrated in FIG. 4, the interior member 16 may press the functional sheet 30 toward an upper side from a lower side of the functional sheet 30. In this case, the interior member 16 presses the connection part 50 on the functional sheet 30 against the roof frame 12F, thus the connection part 50 and the roof frame 12F are kept in the state of being electrically connected to each other. The interior member 16 may have direct contact with the functional sheet 30. When a transmission member 80 described hereinafter is provided on a side of the interior member 16 in the functional sheet 30, the interior member 16 may press the functional sheet 30 via the transmission member 80.

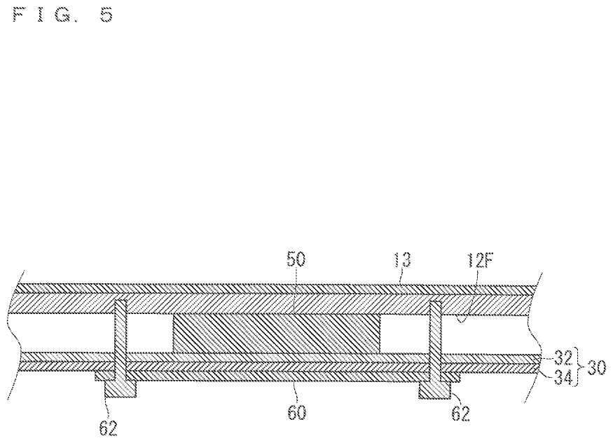

The connection part 50 may be pressed by the other configuration toward the roof frame 12F. A modification example in FIG. 5 illustrates a cross-sectional view in a direction along the roof frame 12F perpendicular to a front-back direction of a vehicle. In the present example, a press member 60 attached to the roof frame 12F presses the connection part 50 toward the roof frame 12F.

More specifically, the press member 60 is an elongated member formed of metal or resin, for example. The press member 60 is formed into an elongated plate-like shape, for example. The press member 60 is formed to be longer than the connection part 50. The press member 60 is provided in a region where the connection part 50 is disposed in a surface of the functional sheet 30 on a side opposite to the roof frame 12F. The press member 60 is fixed to the roof frame 12F by the through fixing part 62 passing through the functional sheet 30. In this fixing state, the press member 60 presses the connection part 50 toward the roof frame 12F from a side of the functional sheet 30. Specifically, both end portions of the press member 60 protrude to an outer side on both sides of the connection part 50. A through hole is formed in each of the both end portions of the press member 60 and a fixing hole is formed in the roof frame 12F. The through fixing part 62 passes through the through hole in each of the both end portions of the press member 60 and the functional sheet 30 to be fixed to the fixing hole of the roof frame 12F. The through fixing part 62 is a screw or a rivet, for example. Accordingly, the press member 60 is fixed to the lower side of the roof frame 12F with a screw. The press member 60 presses the connection part 50 to an upper side between two through fixing parts 62 via the functional sheet 30, thereby pressing the connection part 50 toward the roof frame 12F. Accordingly, the connection part 50 is kept in a state of being electrically connected to the roof frame 12F.

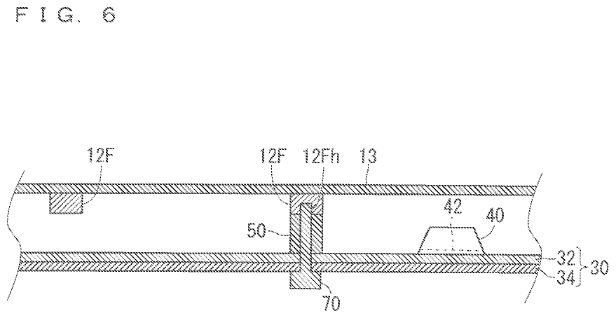

As with the modification example illustrated in FIG. 6, a through fixing part 70 passing through the functional sheet 30 and the connection part 50 may press the connection part 50 toward the roof frame 12F.

More specifically, the through fixing part 70 is a screw or a rivet, for example. The through fixing part 70 passes through the functional sheet 30, and further passes through a through hole 56 formed in the connection part 50 to reach the roof frame 12F. A fixing hole 12Fh is formed in the roof frame 12F, and the through fixing part 70 is fixed to the fixing hole 12Fh. Accordingly, a head of the through fixing part 70 presses the functional sheet 30 toward the roof frame 12F from an opposite side of the roof frame 12F, and the connection part 50 is also pressed toward the roof frame 12F. Accordingly, the connection part 50 is pressed toward the roof frame 12F, and the connection part 50 and the roof frame 12F are kept in a state of being electrically connected to each other.

When the functional sheet 30 is a rigid sheet, the functional sheet 30 may be fixed with a screw or fitted into the body so that the connection part 50 is pressed against the roof frame 12F.

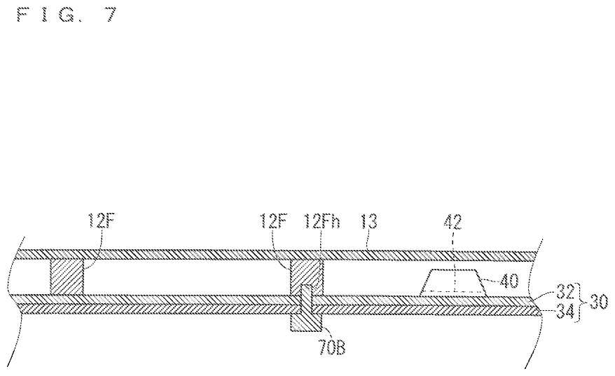

In a modification example illustrated in FIG. 7, the connection part 50 in the embodiment described above is omitted in the modification example illustrated in FIG. 6, for example. Then, a through fixing part 70B corresponding to the through fixing part 70 passes through the functional sheet 30 to be fixed to the fixing hole 12Fh of the roof frame 12F. In this case, a head of the through fixing part 70B presses the functional sheet 30 toward the roof frame 12F from the opposite side of the roof frame 12F. Accordingly, a lower portion of the roof frame 12F in the conductive layer 32 in the functional sheet 30 is pressed toward the roof frame 12F. Accordingly, a part of the surface of the conductive layer 32 is pressed toward the roof frame 12F, and the conductive layer 32 and the roof frame 12F are kept in a state of being electrically connected to each other.

In this case, the through fixing part 70B has contact with the conductive layer 32 and the roof frame 12F to electrically connect the conductive layer 32 to the roof frame 12F. Thus, the through fixing part 70B itself such as a screw or a rivet may be considered the connection part. A part of the surface of the conductive layer 32 may be considered the connection part.

The configuration of pressing the connection part 50 toward the roof frame 12F as with the embodiment and each modification example described above is not necessary. For example, the functional sheet 30 and the roof frame 12F may be bonded in a state of electrically connected by a conductive adhesive agent. In this case, the conductive adhesive agent is the connection part.

The transmission member 80 may be integrated with the functional sheet 30 described above. The transmission member 80 is a member transmitting electrical power or light, for example. For example, the transmission member may be a general wire having a core wire and a covering around the core wire, or may also be a bare conductive wire, a shielded wire, an electrical cable, an enamel wire, a nichrome wire, a coaxial wire, or an optical fiber. The transmission member transmitting the electrical power may be various kinds of signal lines or various kinds of power lines. The transmission member may be a single wire-like object or a composite object of a plurality of wire-like objects (a twisted wire and a cable made up of a plurality of wire-like objects covered by a sheath). The transmission member transmitting the electrical power may be a wiring circuit formed of metal foil, for example, on the main surface of the functional sheet 30. Described herein is an example that the transmission member 80 is a wire-like member transmitting electrical power.

The transmission member 80 is integrated with the functional sheet 30. It is sufficient that the transmission member 80 is integrated with the functional sheet 30 to be disposed along a constant route on the functional sheet 30, thus a specific configuration for integration is not particularly limited.

For example, the transmission member 80 may be fixed to one main surface of the functional sheet 30. For example, the transmission member 80 may be welded (or fused) to one main surface of the functional sheet 30. A welding part thereby formed has a configuration that a part of at least one of the transmission member 80 and/or the functional sheet 30 is melted and adheres to the other side member. The transmission member 80 and the functional sheet 30 may be welded by ultrasonic welding or thermal welding. It is also applicable that a surface of at least one of the transmission member 80 and/or the functional sheet 30 is melted by a solvent to weld the transmission member 80 and the functional sheet 30. For example, the transmission member 80 may be fixed to the functional sheet 30 by an adhesive agent or a double-sided tape, for example. For example, the transmission member 80 may be sewn to the functional sheet 30 by a sewing thread. It is also applicable that an adhesive tape is attached to a portion from a side of one main surface of the functional sheet 30 to the transmission member 80 in a state where the transmission member 80 is disposed on one main surface of the functional sheet 30 to fix the transmission member 80 to one main surface of the functional sheet 30, for example. The transmission member 80 needs not be fixed to only one main surface of the functional sheet 30. The transmission member 80 may include both a part fixed to one main surface of the functional sheet 30 and a part fixed to the other main surface of the functional sheet 30. In this case, the transmission member 80 may be provided to pass from one main surface toward the other main surface in a middle portion or an end edge portion of the functional sheet 30.

For example, the transmission member 80 may be sandwiched between two sheets, thereby being fixed to the functional sheet 30. For example, in a case where the functional sheet 30 includes a plurality of layers, the transmission member 80 may be sandwiched between sheets constituting each layer. In a case where the other sheet overlaps with the functional sheet 30, the transmission member 80 may be sandwiched between the functional sheet 30 and the other sheet. In this case, the two sheets sandwiching the transmission member 80 may be fixed by welding, or may also be fixed by an adhesive agent or a double-sided tape.

Illustrated in the present example is an electrical wire 80 electrically connected to the antenna unit 40 as an example of the transmission member 80 (refer to FIG. 2).

The functional sheet 30 may be provided with an apparatus 90 other than the antenna unit 40 (refer to FIG. 2). The apparatus 90 may be an electrical control unit (ECU) controlling an apparatus provided to the roof panel 13, and in addition, a lamp or a camera, for example, is also applicable. FIG. 2 also illustrates the electrical wire 80 electrically connected to the apparatus 90 as example of the transmission member 80.

The electrical wire 80 is fixed to any of the surfaces of the functional sheet 30, thereby being held along a constant route. It is also applicable that the electrical wire 80 is introduced toward a pillar of the body 12, and is electrically connected to an apparatus on a vehicle side via the pillar. The electrical wire 80 may also be electrically connected to the other apparatus provided on a roof side.

According to the antenna module 20 having such a configuration, the ground conductor 42 of the antenna unit 40 is electrically connected to the conductive layer 32 of the functional sheet 30. Thus, even in a case where the antenna unit 40 is not assembled to a metal portion of a vehicle, for example, the antenna unit 40 is easily ground-connected. Even in a case where the roof panel is not made up of insulative resin, the antenna unit 40 is easily ground-connected. Thus, the application of the antenna module 20 is not based on a premise that the roof panel 13 is made of insulative resin.

Described in the present embodiment is an example that the ground conductor 42 is electrically connected to a metal portion (the roof frame 12F herein) of the body 12 via the conductive layer 32 and the connection part 50. Thus, the ground conductor 42 is ground-connected more easily via the conductive layer 32 and the connection part 50.

The functional sheet 30, particularly the functional sheet 30 including the layer 34 having at least one of the heat insulating function and/or the acoustic insulating function achieves the function in an area as large as possible, thus is provided to extend to some degree. Thus, the antenna unit 40 is easily ground-connected using the functional sheet 30 provided in a large area to some degree in such a manner. Accordingly, the antenna unit 40 which has been ground-connected previously can be incorporated into the vehicle 10.

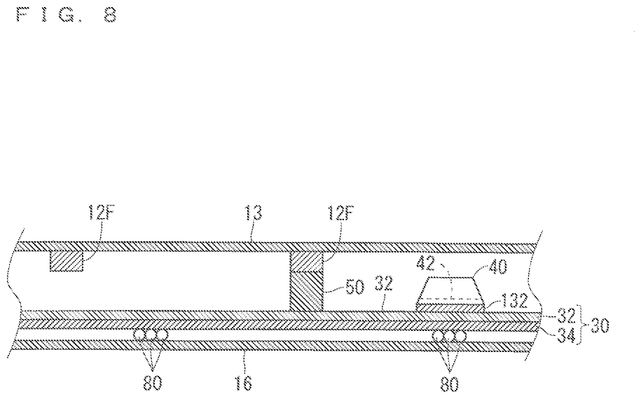

As with a modification example illustrated in FIG. 8, a ground plate 132 may be provided on a surface of the antenna unit 40 on a side where the functional sheet 30 is provided. The ground plate 132 is a metal plate formed of metal such as aluminum, for example. The ground plate 132 has higher rigidity than the functional sheet 30, and has rigidity large enough to be hardly bended by a hand working, for example. For example, the ground plate 132 is formed to have a thickness of 5 mm or more. The ground plate 132 may have the same size as a bottom surface of the antenna unit 40, or may also extend to be larger than the bottom surface thereof. The ground plate 132 is fixed to the antenna unit 40 by a conductive adhesive agent, a screw, or soldering, for example. The ground conductor 42 of the antenna unit 40 is electrically connected to the ground plate 132. The ground conductor 42 and the ground plate 132 can be electrically connected by soldering or a screw for screwing, for example.

The antenna unit 40 is attached to the functional sheet 30 while the ground plate 132 faces the conductive layer 32. The attachment of the ground plate 132 to the functional sheet 30 may be performed in the manner similar to the attachment of the antenna unit 40 to the functional sheet 30.

Accordingly, the ground conductor 42 is electrically connected to the conductive layer 32 via the ground plate 132. The ground plate 132 is a rigid plate, and faces the conductive layer 32 in a relatively large area. Thus, the ground plate 132 and the conductive layer 32 are electrically connected stably.

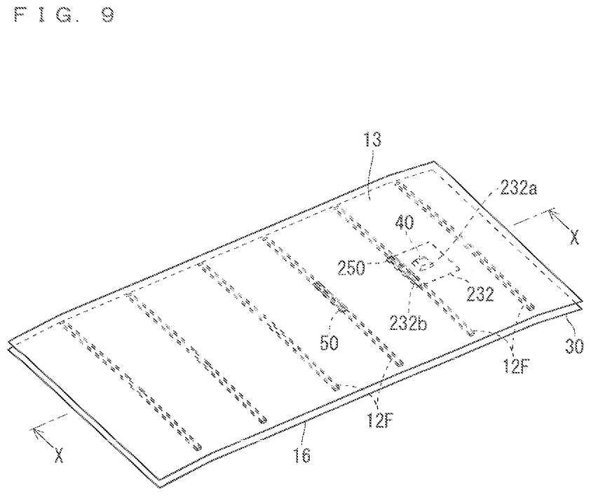

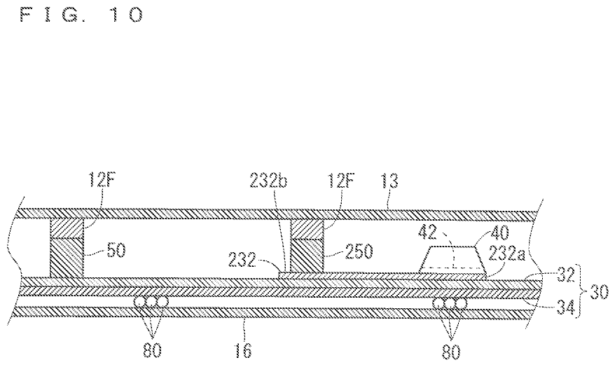

As illustrated in FIG. 9 and FIG. 10, a ground plate 232 corresponding to the ground plate 132 may include a body part 232a disposed between the antenna unit 40 and the functional sheet 30 and an extension part 232b extending from the body part 232a toward an outer side of the antenna unit 40. The extension part 232b may extend toward a metal portion of a body such as a lower side of the roof frame 12F, for example.

An additional connection part 250 may be provided to the extension part 232b. The additional connection part 250 is a portion similar to the connection part 50 described above. The connection part 50 is provided to the extension part 232b by a configuration similar to the configuration that the connection part 50 is provided to the functional sheet 30. The connection part 50 may be connected to the roof frame 12F by a configuration similar to the configuration that the connection part 50 is electrically connected to the roof frame 12F.

The connection part 50 may be electrically connected to the roof frame 12F in a position different from the roof frame 12F to which the additional connection part 250 is electrically connected.

According to the present example, the ground conductor 42 of the antenna unit 40 is electrically connected to the roof frame 12F via the additional connection part 250 and the connection part 50. Thus, the ground conductor 42 of the antenna unit 40 is electrically connected to the metal portion of the body 12 more reliably.

The example of the conductive layer 32 provided in a side of the antenna unit 40 (upper side) in the functional sheet 30 is described in the embodiment and each modification example described above. However, the conductive layer 32 may be provided on an opposite side (lower side) of the functional sheet 30 from the antenna unit 40. In this case, the conductive layer 32 and the ground conductor 42 (or the ground plates 132 and 232) or the connection part 50 may be electrically connected to each other by a through fixing member such as a screw or a rivet passing through the functional sheet 30.

Each configuration described in the embodiment and each modification example can be appropriately combined as long as they are not contradictory.

### EXPLANATION OF REFERENCE SIGNS

10 vehicle
12 body
12F roof frame
13Fh fixing hole
12h roof panel opening
13 roof panel
14 roof
16 interior member
20 antenna module
30 functional sheet
32 conductive layer
34 layer
40 antenna unit
42 ground conductor
50 connection part
56 through hole
60 press member
62, 70, 70B through fixing part
80 transmission member (electrical wire)
90 apparatus
132, 232 ground plate
232a body part
232b extension part
250 additional connection part

1. An antenna module, comprising:
a functional sheet including a conductive layer and a layer having at least one of a heat insulating function and/or an acoustic insulating function; and
an antenna unit including a ground conductor, wherein
the functional sheet is disposed between a panel forming an outer shape of a vehicle and an interior member provided on a side closer to a vehicle interior than the panel,
the ground conductor is electrically connected to the conductive layer, and
a transmission member transmitting electrical power or light is held along a constant route by the functional sheet.

2. The antenna module according to claim 1, wherein
a connection part electrically connecting the conductive layer to a metal portion of a body is provided to the functional sheet.

3. The antenna module according to claim 1, wherein
the antenna unit includes a ground plate electrically connected to the ground conductor, and
the ground plate and the conductive layer face each other.

4. An antenna module comprising:
a functional sheet including a conductive layer and a layer having at least one of a heat insulating function and/or an acoustic insulating function; and
an antenna unit including a ground conductor, wherein
the functional sheet is disposed between a panel forming an outer shape of a vehicle and an interior member provided on a side closer to a vehicle interior than the panel,
the ground conductor is electrically connected to the conductive layer,
the antenna unit includes a ground plate electrically connected to the ground conductor,
the ground plate and the conductive layer face each other,
the ground plate includes an extension part extending from the antenna unit, and
an additional connection part electrically connected to a metal portion of a body is provided to the extension part.

5. An antenna module, comprising:
a functional sheet including a conductive layer and a layer having at least one of a heat insulating function and/or an acoustic insulating function; and
an antenna unit including a ground conductor, wherein
the functional sheet is disposed between a panel forming an outer shape of a vehicle and an interior member provided on a side closer to a vehicle interior than the panel,
the ground conductor is electrically connected to the conductive layer,
an apparatus other than the antenna unit is provided to the functional sheet, and
a transmission member connected to the antenna unit and a transmission member connected to the apparatus are held along a constant route by the functional sheet.
